(19) United States
(12) Patent Application Publication
(10) Pub. No.: US 2007/0253180 A1
(43) Pub. Date: Nov. 1, 2007

(54) Drawing easily slice structure for interface card

(76) Inventor: Ming-Huang Chiang, Taipei Hsien (TW)

Correspondence Address: CHIANG, MING-HUANG, WUGU INDUSTRIAL PARK, 4F., NO.51 WUQUAN 7TH RD, TAIPEI HSIEN, 248-90, TW

(21) Appl. No.: 11/633,598

(22) Filed: Apr. 26, 2006

(51) Int. Cl. H02B 1/01

(52) U.S. Cl. 361/825

(57) ABSTRACT

This invent is an improved drawing easily slice for the interface car mainly for pulling out the interface card from the chassis of the computer and the main board easily, insides: there are several expansion slots on the main board; there is a fixing base on the chassis of the computer, and a lateral side on one side of the fixing base; the interface card includes: An inserting slice, it is used to be inserted into the expansion slot; A lateral side, a tetragonal bolt hole in it for the bolt to go through; A pushing piece, set a hole, and is fixed with the lateral side in swinging style. Also there are a pushing part and a supporting part on the pushing piece. The supporting part extends to the top of the lateral side, and the exerting part extends to the outside of the fixing slice, so it can be exerted easily and the supporting part can be swung a certain angle. In this way, we can exert the exerting slice of the pushing piece, then the supporting part can push the lateral side of the fixing base, then the interface card can have a reacting force, by this reacting force the interface card can be pulled out from the expansion slot more easily, quickly and conveniently for the benefits of users' installment.

### FIELD OF THE INVENTION

This device is an improved drawing easily slice for the interface card, especially it can help the interface card to be pulled out more easily, more quickly and more conveniently for the benefits of users' installment.

### DESCRIPTION OF THE PRIOR ART

Recently, as the development, convenience and popularization of the computer, it is a trend that every family has a computer. People now use computer to deal with more various things. In order to make computer work in accordance with everyone's own needs, now design a new main board. The new one can be connected with various interface slices according to users' needs, so that it has many functions and can be connected with different pieces of equipment.

As FIG. 8 shows, the common interface card 4 mainly includes an inserting slice 40 and a fixing slice 41. The inserting slice 40 is mainly for inserting into the slot 51 of the expansion slot 50 of the main board 5. The fixing slice 41 adheres to one lateral side of the fixing base 60 of the chassis of the computer frame 6. There is a protruding slice 42 on one end of the fixing slice, and the protruding slice is used to be inserted into the nesting 61 of the fixing base 60, while on the other end, there is a vertical rolled over slice 43 as used to adhere to one lateral side 62 of the fixing base 60, and there is a slot hole 44 in the rolled over slice 43, so one screw 45 can be used to go through the hole and screw the rolled over slice with the screw hole 63 on the lateral side 62, so that the fixing slice 41 can be fixed on the fixing base 60.

But, because when the inserting slice 40 of the common interface card 4 is inserted into the slot 51 of the expansion slot 50, in order to avoid bad connecting or dropping easily, all the ends of the slot 51 will press the inserting slice 40, so it will not be pull out easily when the screw 45 is loosed and the interface card 4 is ready to pull out of the expansion slot 50, because there are not any exerting easily points on the interface card 4. Besides, when common users pull out the interface card 4, sometimes without proper exerts, it can also cause other problems such as destroy the interface card 4, the electronic parts of the interface cards 4, or the other parts of the computer frame 6, or even hurt users.

In order to make a new interface card, the designer worked hard for a long time, thought deeply and invented the new device that overcome the short comings of the former one.

### SUMMARY OF THE INVENTION

This invent is an improved drawing easily slice for the interface card, used to help the interface card to be pulled out more easily, quickly and conveniently for users' installment.

Exactly, that is mainly to pull out the interface card from the chassis of the computer and the main board easily, including:

There are several expansion slots on the main board.

There is a fixing base on the chassis of the computer, and a lateral side on one side of the fixing base.

The interface card includes:

An inserting slice, it is used to be inserted into the expansion slot;

A lateral side, a tetragonal slot hole in it for the slot to go through;

A pushing piece, set a hole, and is fixed with the lateral side in swinging style. Also there is a pushing part and an exerting part on the pushing piece. The pushing part extends to the top of the lateral side, and the exerting part extends to the outside of the fixing slice, so it can be exerted easily and the pushing part can be swung a certain angle.

In this way, we can exert the exerting slice of the pushing piece, then the supporting part can push the lateral side of the fixing base, then the interface card can have a reacting force, by this reacting force the interface card can be pulled out from the expansion slot more easily, quickly and conveniently for the benefits of users' installment

### BRIEF DESCRIPTION OF THE DRAWINGS

FIG. 1 is a stereo exploded view of a good using example of the invention.

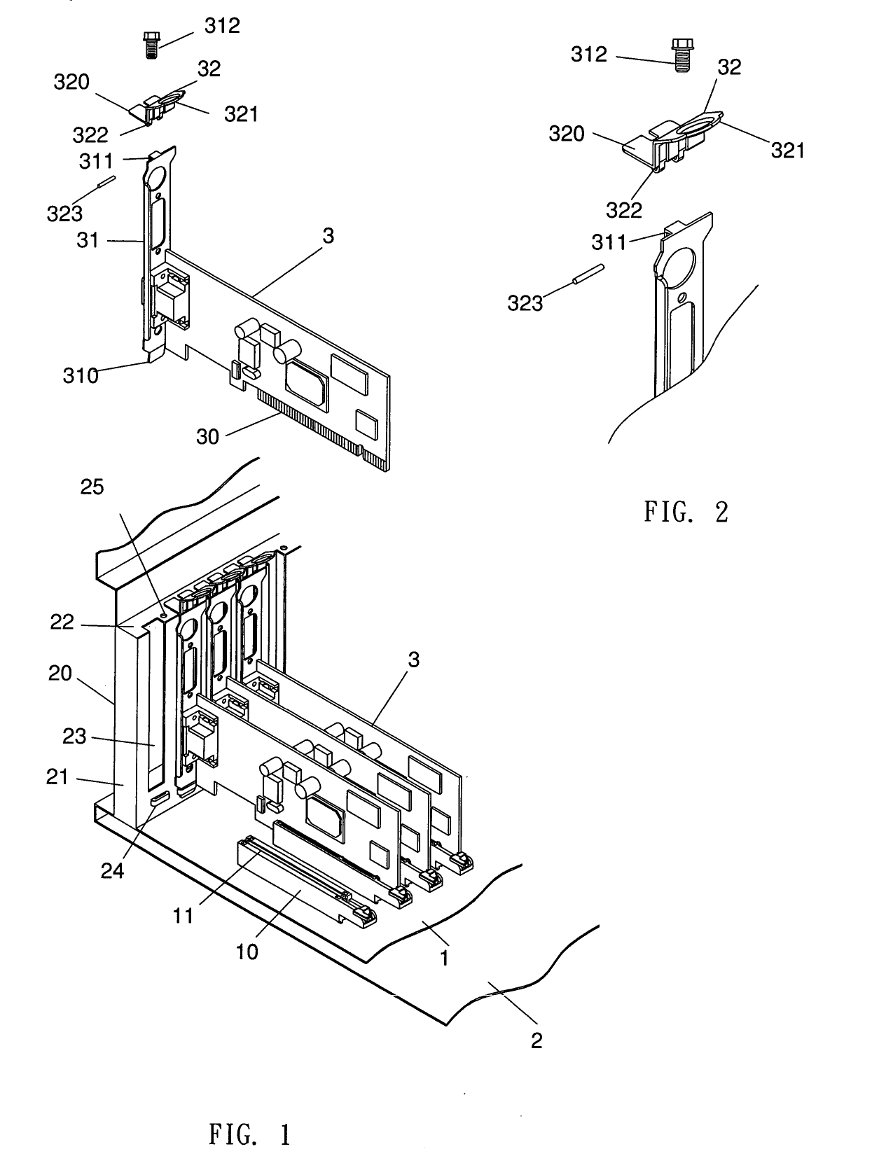

FIG. 2 is a close-up view of a good using example of the invention.

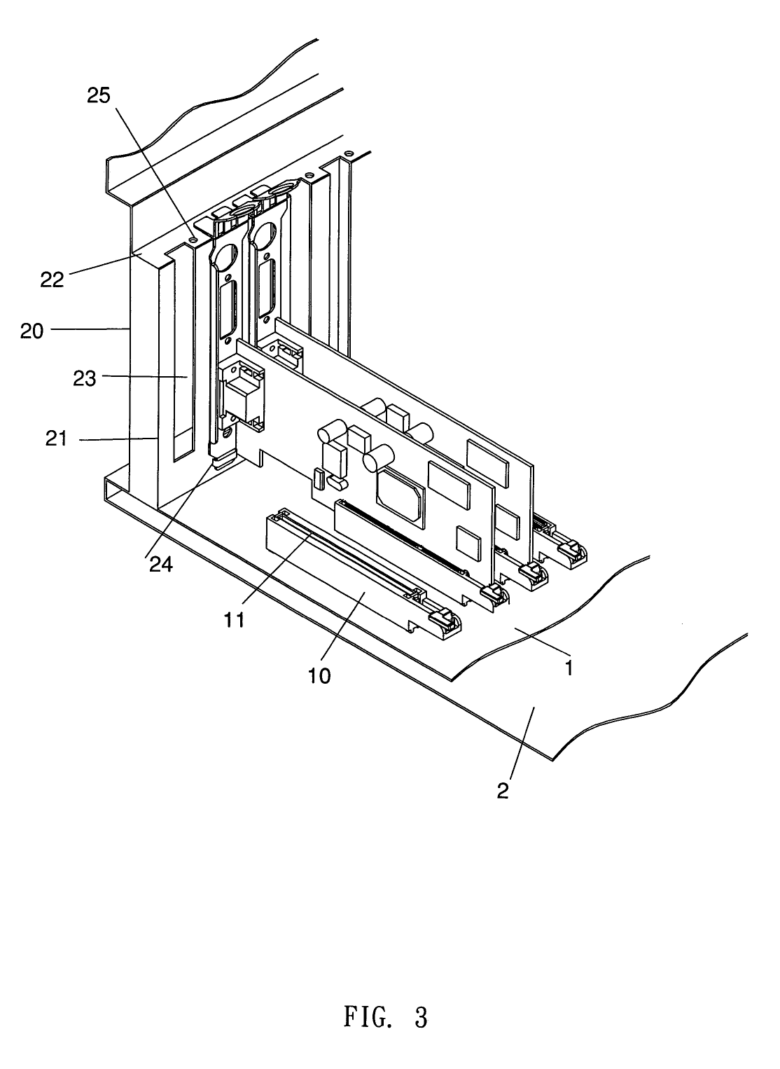

FIG. 3 is a stereo outside view of a good using example of the invention.

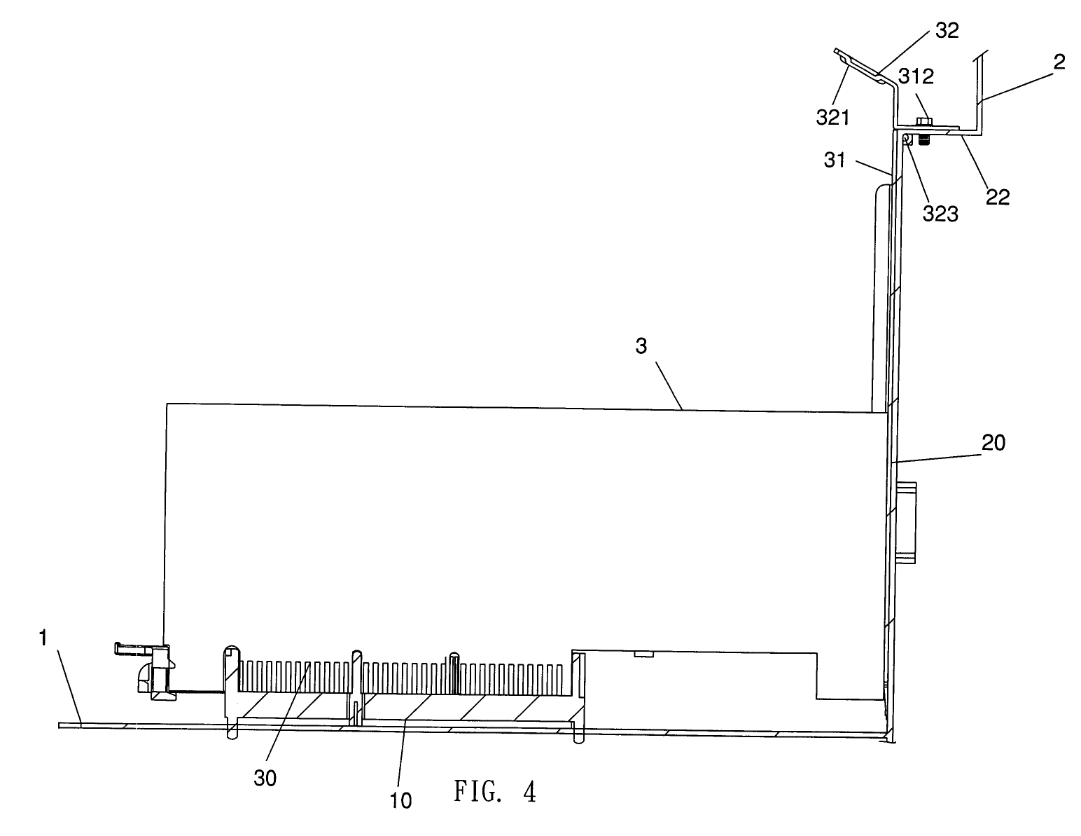

FIG. 4 is a side view of a good using example of the invention.

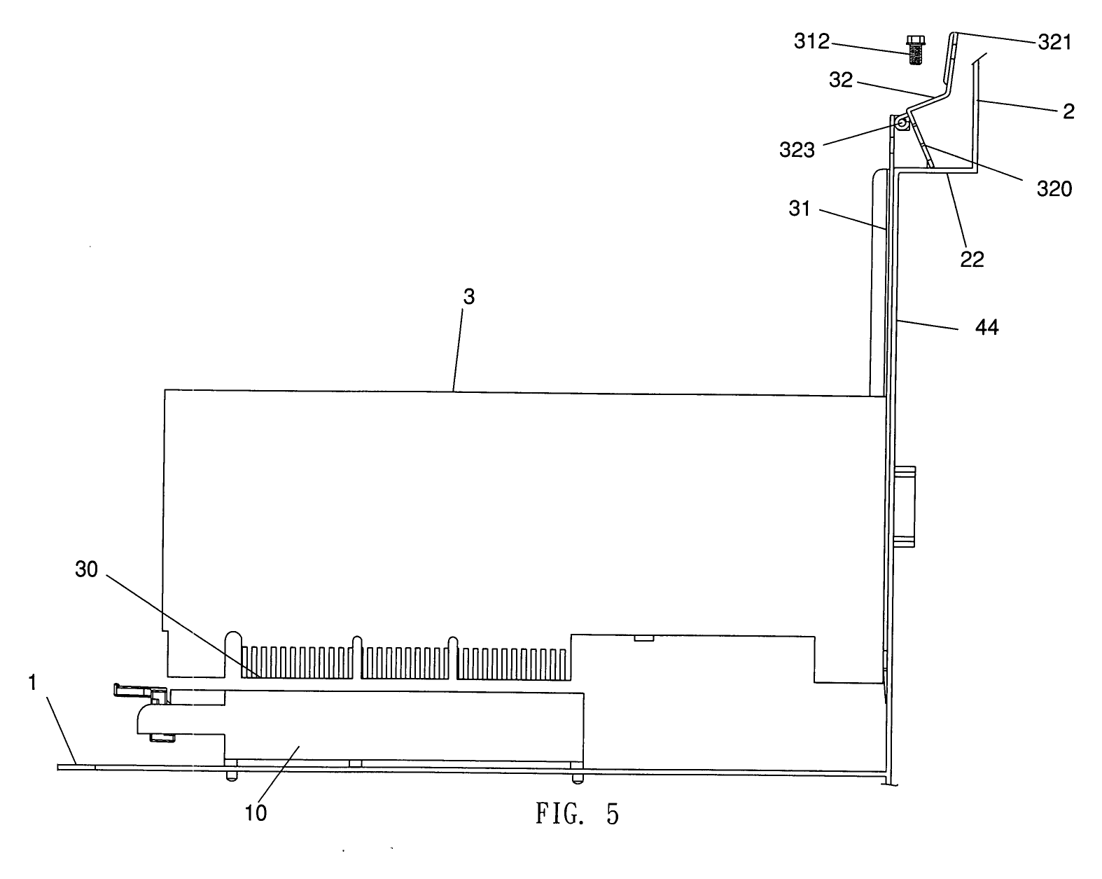

FIG. 5 is a working view of a good using example of the invention.

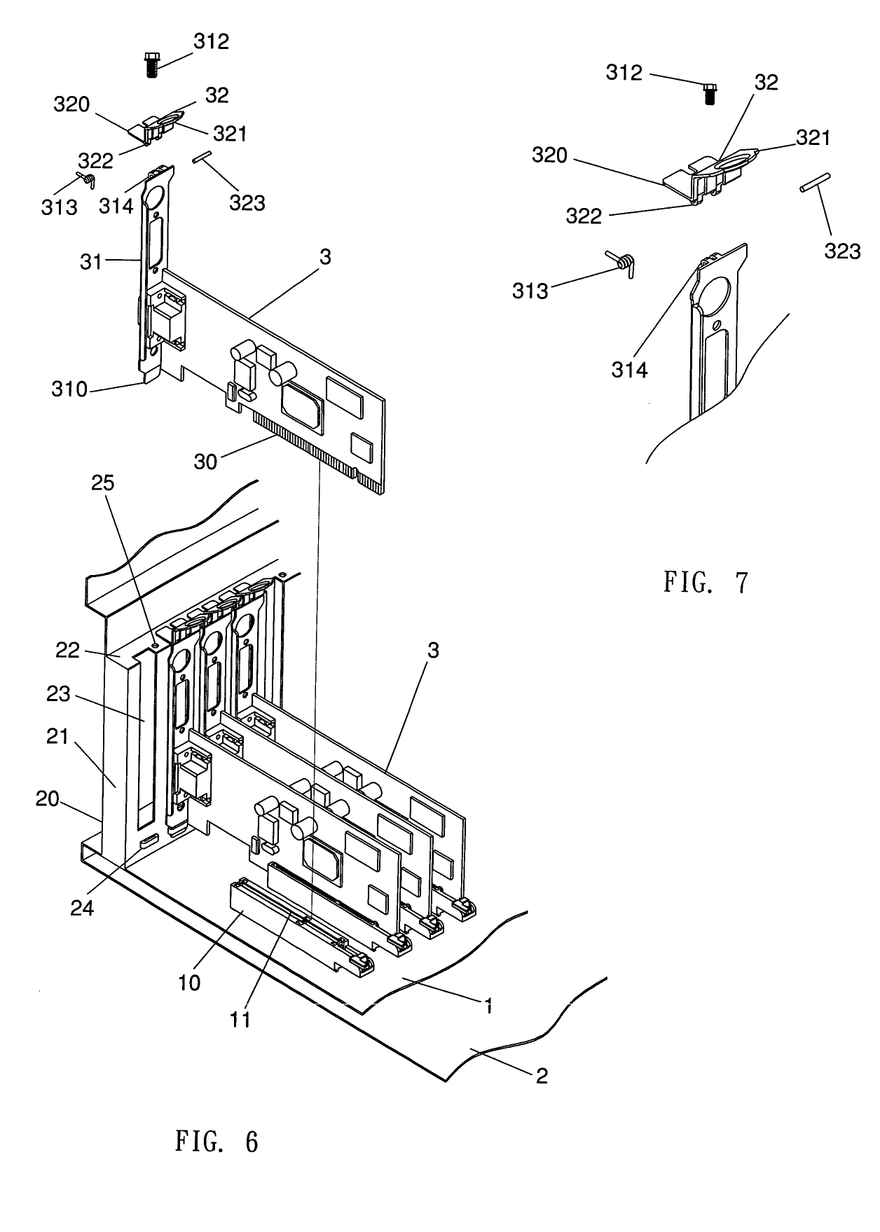

FIG. 6 is a stereo exploded view of the common interface card.

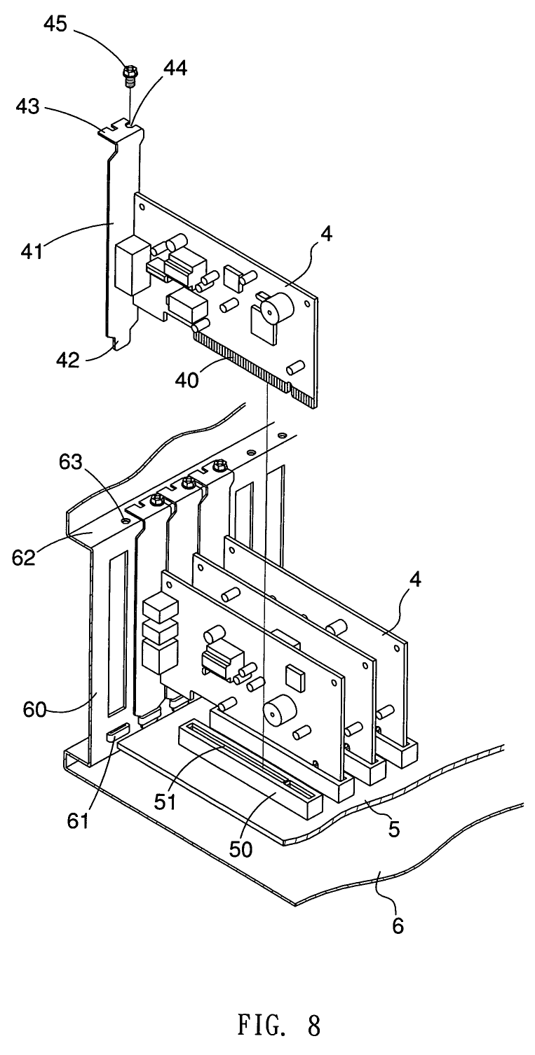

### DETAILED DESCRIPTION OF THE PRESENT INVENTION

Please reference picture 1˜5, it is the first good using example of the drawing easily slice for the interface card referred in this invent, the improved drawing easily slice for the interface card mainly to help the interface card 3 to be pulled out from the chassis of the computer 2 and the main board 1 more easily, quickly and conveniently for users' installment. The structures are as the followings:

There are several expansion slots 10 on the main board 1 and the expansion slots 10 have slots 11 for the interface card 3 to go through;

There is a fixing base 20 protruding on the chassis of the computer 2 and the fixing base 20 has a fixing side 21 and a lateral side which is upright to the lateral side 22 of one side of the fixing side 21. This fixing side 21, matching the place of the expansion plots, has perforation 23 for the connector of interface card 3 to go through. Besides, opposite to perforation 23 outside of one end of the lateral side 22, the fixing side 21 is set a run-through nesting 24 while there is a screw hole 25 in the hole 23 of the lateral side 22.

The interface card 3 includes:

An inserting slice 30, it is used to be inserted into the slot 11 of the expansion slot 10;

A lateral side 31, adhering to the fixing side 21 of the fixing base 20, one end is set a protruding slice 310 used to be inserted into the nesting 24 and the other end is set a slot hole 311 for a slot 323 to go through;

A pushing piece 32, set a hole 322 for the slot hole 311 and the slot 323 to go through and the slot is fixed with one side of the lateral side 31. The pushing piece 32 can be swung a certain angel taking slot hole 311 as the center. Also there are a pushing part 320 and an exerting part 321 on the other side of the pushing part 320 for the pushing piece 32. The pushing part 320 extends to the top of the lateral side 22, and the exerting part 321 extends to the outside of the pushing piece 32, so it can be exerted easily and the pushing part 320 can be swung a certain angle taking the slot hole 311 as the center. There is in a tetragonal slot hole 311 used to fix the angle when the pushing piece 32 is swung, then it can't be upright.

Please reference picture 5, when the screw 312 is loosed from the screw hole 25 and can be pulled upward by the exerting part 321 of the pushing piece 32, for the pushing part 320 swinging downward the lateral side 22 of the pushing piece, then the interface card 3 can have a reacting force upward, by this reacting force the slot part 30 of the interface card 3 can be pulled out from the slot 11 of the expansion slot 10 more easily, more quickly and more conveniently for the pulling of the interface card 3.

Please reference picture 6 and 7, it is the second good using example of the drawing easily slice, structures of it are generally the same as the first one, while the difference is that: the pushing piece 32 of the second one makes use of a spring 313 set in middle of the slot hole 314, combined with the slot 323 to go through to make the pushing piece 32 can be swung, when the pushing piece 32 is pulled upward to pull out the interface card 3 from the slot 11 of the expansion slot base 10, the spring 313 will have a reaction force which can recover the pushing piece 32 to the state of not being pulled.

Sum up, for the elaborate design, this invent has all the above advantages and practical values. And there are no simulate products or publications among similar products. Therefore this invent conforms to the important documents of application for the patent of new pattern, now I ask for the application according to the law.

I claim:

1. This invent is an improved drawing easily slice for the interface card, mainly used to pull out the interface card from the chassis of the computer and the main board easily, including: There are several expansion slots on the main board; There is a fixing base on the chassis of the computer, and a lateral side on one side of the fixing base; The interface card includes:
An inserting slice, it is used to be inserted into the expansion slot;
A lateral side, a tetragonal slot hole in it for the slot to go through;
A pushing piece, set a hole, and is fixed with the lateral side in swinging style:
Also there are a pushing part and an exerting part on the pushing piece. The pushing part extends to the top of the lateral side, and the exerting part extends to the outside of the fixing slice, so it can be exerted easily and the pushing part can be swung a certain angle.

2. This invent is an improved drawing easily slice for the interface card, mainly used to pull out the interface card from the chassis of the computer and the main board easily, including: There are several expansion slots on the main board; There is a fixing base on the chassis of the computer, and a lateral side on one side of the fixing base;
The interface card includes:
An inserting slice, it is used to be inserted into the expansion slot;
A lateral side, set with a slot hole and a spring (which is in the center of the slot hole) for the slot to go through;
A pushing piece, set a hole, and is fixed with the lateral side in swinging style. Also there is a pushing part and an exerting part on the pushing piece. The pushing part extends to the top of the lateral side, and the exerting part extends to the outside of the lateral side, so it can be exerted easily and the pushing part can be swung a certain angle.

3. Just as article 1 and 2 of Requirements of the Rights, the figure of the drawing easily slice for the interface card is that: there is screw hole in the lateral side relative to the expansion slot, and the slot hole of the interface card can be used for the slot to go through.

4. Just as article 1 of Requirements of the Rights, the figure of the drawing easily slice for the interface card is that: there is a tetragonal slot hole in it for the slot to go through and the angle of the pushing piece swinging can be fixed.

5. Just as article 1 and 2 of Requirements of the Rights, the figure of the drawing easily slice for the interface card is that: there are a pushing part and an exerting part on the pushing piece. The pushing part extends to the top of the lateral side, and the exerting part extends to the outside of the lateral side, so it can be exerted easily and the pushing part can be swung a certain angle.

6. Just as article 2 of Requirements of the Rights, the figure of the drawing easily slice for the interface card is that: the pushing piece makes use of a spring set in middle of the slot hole, combined with the slot to go through to make the pushing piece can be swung.

7. Just as article 2 of Requirements of the Rights, the figure of the drawing easily slice for the interface card is that: when the interface card is pulled out from the slot of the expansion slot base, the spring will have a reaction force which can recover the pushing piece to the state of not being pulled.
